(19) United States
(12) Patent Application Publication
(10) Pub. No.: US 2007/0094138 A1
(43) Pub. Date: Apr. 26, 2007

(54) Method for dispensing, paying for, and advertising prescription drugs

(76) Inventor: James Andrews, Albuquerque, NM (US)

Correspondence Address: PEACOCK MYERS, P.C., 201 THIRD STREET, N.W., SUITE 1340, ALBUQUERQUE, NM, 87102, US

(21) Appl. No.: 11/445,531

(22) Filed: Jun. 1, 2006

Related U.S. Application Data
(60) Provisional application No. 60/596,356, filed on Sep. 19, 2005.

(51) Int. Cl. G06Q 40/00

(52) U.S. Cl. 705/40

(57) ABSTRACT

A method and system wherein a customer contracts with a pharmacy product distribution organization to make installment payments for medical products and wherein a customer can be provided with full prescription including, but not limited to, one or more years supply of the prescription.

### CROSS-REFERENCE TO RELATED APPLICATIONS

This application claims priority to and the benefit of the filing of U.S. Provisional Patent Application Ser. No. 60/596,356, entitled The Distribution of Prescription Pharmacy Products to End Consumers Using an Installment Payment Plan, filed on Sep. 19, 2005, and the specification thereof is incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention (Technical Field)

The present invention relates to a method and system for dispensing, paying for, and advertising prescription drugs. Particularly, the present invention relates to a method wherein a medical supply provider provides a quantity of medical products prescribed by a health care provider (for example, a year's supply of medication) and bills the recipient on a regular basis (for example, every month).

2. Description of Related Art

Note that the following discussion refers to a number of publications by authors and year of publication, and that due to recent publication dates certain publications are not to be considered as prior art vis-a-vis the present invention. Discussion of such publications herein is given for more complete background and is not to be construed as an admission that such publications are prior art for patentability determination purposes.

Due to the continually rising costs of healthcare, numerous inventions have been created in an effort to streamline numerous aspects of medical care, encourage repayment for healthcare debt, and/or otherwise create billing schemes which make medical care more accessible to patients who have inadequate healthcare insurance or no healthcare insurance at all.

U.S. Patent Application No. 2005/0010438 to York et al., for example, describes an invention wherein a patient enters into a financing agreement with a healthcare provider. A servicing company sends periodic credit card styled statements which can include interest and/or fees to the patient in an attempt to cause the patient to pay for the services rendered. That application explains that patients typically regard healthcare debt as a lesser important debt and credit card styled statements help remedy that problem. The York et al. invention is thus focused primarily on causing a patient to recognize and thus pay for a healthcare-related financial obligation.

U.S. Patent Application No. 2003/0050795 to Baldwin, Jr. et al. is directed to an invention wherein fees and costs associated with an anticipated medical procedure can be calculated. After this calculation, the credit worthiness of the patient is calculated and a full or partial loan can be offered to the patient.

U.S. Pat. No. 6,453,297 to Burks et al. is for a system which enables a plurality of healthcare providers to communicate with a plurality of financial institutions to better enable patients to obtain lines of credit for medical services.

U.S. Pat. No. 6,208,974 to Campbell et al. is for a system which helps a patient choose and accept a wellness plan. The system also includes computer software which enables the patient to sign up for a payment plan.

None of the prior art describe that an entire prescription can be issued to a patient, nor do any of the prior art describe that installment payments can be used to pay for a full prescription. Additionally, the prior art references fail to teach that advertisements can be included in the bills and/or receipts which are generated for the installment payments and that such advertising space can be sold to third parties. There is thus a present need for an invention which provides the ability for a full prescription to be issued to a patient such that multiple trips to a pharmacy are not required. There is further needed an invention which encourages regular contact between a healthcare product distributor and a patient and which contact provides the ability to deliver targeted advertisements to the patients.

### BRIEF SUMMARY OF THE INVENTION

The present invention is of a method for distributing and paying for prescriptions, comprising: a customer contracting with a pharmacy product distribution organization to make installment payments for prescriptions; a physician issuing a full prescription for a pharmacy product; a pharmacy product distribution organization shipping the full quantity of medical product prescribed; and installment payments being made for the prescribed product. In the preferred embodiment, the installment payments are paid in response to billing statements sent by the distribution organization. The installment payments are automatically paid by the customer and the distribution organization issues a receipt for payments made by the customer. The distribution organization may send advertisements to a customer, preferably in conjunction with a billing statement or a receipt. The distribution organization may sell advertising space to a third party. At least a percentage of each installment payment may be paid by an insurance provider, and the customer pays at least a portion of the installment payments.

The invention is also of a method for distributing and paying for prescriptions, comprising: contracting with a product distributor, the contract providing for installment payments to be made to the product distributor; issuing a prescription; providing a prescribed product to the individual named on the prescription; and providing installment payments to a distributor. In the preferred embodiment, contracting comprises a customer contracting with a product distributor and optionally additionally an insurance provider contracting with the product distributor. The customer may then contract with the insurance provider, wherein the customer contracts to make all or a percentage of each installment payment to the insurance provider. Issuing a prescription preferably comprises issuing a full prescription. Providing a prescribed product comprises dispensing a prescribed product to the individual named on the prescription and comprises the individual named on the prescription taking possession of the product at a distribution outlet. Providing installment payments comprises an individual making at least a percentage of each installment payment to the product distributor and optionally an insurance provider making at least a percentage of each installment payment to the product distributor. A bill is provided to the individual named on the prescription. Advertisements may be provided along with the bill, and advertisement space may be sold. Providing installment payments comprises automatically deducting at least one installment payment from an account and the method additionally provides a receipt for payment. Advertisements may be provided along with the receipt for payment.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a block diagram illustrating an embodiment of the present invention for the generation and issuance of a prescription, as well as for product distribution to a consumer; and

FIG. 2 is a block diagram illustrating an embodiment of the present invention for the billing and payment of a pharmacy product.

### DETAILED DESCRIPTION OF THE INVENTION

The term “prescription” as used throughout the specification and claims is intended to include any and all medical and medically related supplies prescribed by an authorized health care practitioner. The term “prescription” is thus not limited strictly to prescription-only drugs, but rather also includes any and all over-the-counter drugs as well as any and all non-drug medical supplies including but not limited to devices, apparatuses, and other items. In addition, the pharmacy product distribution organization referred to throughout this application includes organizations providing one or more prescriptions as described herein.

The present invention relates to a method for distributing prescription pharmacy products to end consumers using an installment payment plan. A preferred embodiment of the present invention comprises: A customer preferably signing a payment contract with a pharmacy product distribution organization (“PPDO”) and taking delivery of a supply of medical product. The contract affirms that the consumer will pay for the product over the period of consumption. The contract can specify that a portion of the contract may be paid by an assignee. The contract can specify the method of payment (credit card, bank account for direct debit, bill by mail, etc.). The distribution organization gets the benefit of establishing a long-term contractual relationship with its customer where none existed before.

In the method of the present invention, the entire prescription pharmacy product can be dispensed in accordance with the medical provider's instructions. The amount dispensed is not constrained by insurance company or Medicare/Medicaid rules. For example, if the prescription is a supply for one year or more, then the entire amount can be dispensed at one time. The PPDO can bill and collect the funds per the contract. In one embodiment, the PPDO can notify the consumer via email every time a successful payment has been collected or if a payment was not received. This gives the dispensing organization an opportunity to market to this consumer on a regular basis. By maintaining regular contact with the customer, the PPDO can increase renewal rates offer expedited renewal processes. The dispensing organization can optionally use an Internet portal to enable consumers to view their account status, allow them to update demographic information, and update billing information. As consumers move, they can be referred to new medical providers that subscribe to the payment system of the present invention.

Because the dispensing organization is aware of when each customer will run out of a product, a simplified renewal/reorder process can be marketed and/or implemented. The simplified process can include the prescribing health care provider, the PPDO, and the consumer saving time and money. The system and method of the present invention can optionally include a centralized shipping department which can reduce decentralized inventory levels. Optionally, the renewals can be done online (to the extent allowed by law). The healthcare provider who initially wrote the original prescription or another healthcare provider is preferably notified that the consumer needs a renewal of his/her prescription by a certain date. The consumer will be notified that his/her prescription is running low and can be instructed how and where to renew their prescription.

Compensation can optionally be paid to subscribing healthcare providers or their staff (where allowed by law) when their patients sign a contract with a pharmacy product distribution organization (“PPDO”). Medical providers who subscribe to the method and system of the present invention can optionally receive renewal information and patient status information. In one embodiment, a subscribing medical provider can be provided the ability to include messages and marketing information on the billing invoice or receipt issued for payments automatically made. Further, new healthcare providers who are not already participating in the method and system can optionally be allowed to sign up at any time in the future.

Insurance companies and Medicare/Medicaid can subscribe with the PPDO in order for their members to receive the benefit of this distribution system. If the end consumer lets his/her private or public insurance lapse, he/she is responsible for the payment of the full amount of all remaining payments for the term of the remainder of the contract.

By establishing a long-term contractual relationship, the consumer preferably obtains the benefit of receiving the pharmaceutical product(s) upfront, without the need to continuously seek refills, while the PPDO preferably receives the benefit of a regular cash flow, increased targeted marketing abilities, and continuing and regular customer contact. Further, dispensing and travel costs can be greatly reduced when the full supply of prescriptions are issued, rather than smaller portions thereof.

With the present invention, the patient enjoys considerable freedom and piece of mind as he/she is confident that he/she will not run out of medication. The manufacturer ships a larger amount of product, increasing its revenue. The dispensing organization reduces its dispensing costs because the dispensing occurs only once and not multiple times. The customer care and long-term contracting aspects of the invention enable pharmacy distribution organizations, insurance companies and medical providers to build long-term business relationships with their customers.

In addition, by delivering a full prescription to the patient, it is more likely that the patient will take their entire prescription. The patient no longer needs to make periodic trips to the pharmacy or make periodic requests from a mail order pharmacy. Rather than limit the dispensed product to the amount allowed by an insurance plan, the patient instead preferably signs a contract that he/she is ultimately responsible for the payment of the medication. The customer care and long-term contracting aspects of the invention enable pharmacy distribution organizations, insurance companies and medical providers to build long-term business relationships with their customers.

In one embodiment, the insurance company can enter into the payment contract with the PPDO and then subsequently bill the customer (patient) for any and all sums which are to be paid by or reimbursed by the customer. Optionally, the insurance provider can sign the installment payment contract with the PPDO and then enter into a separate contract with a customer such that the customer is bound to pay all or a portion of the amount paid out by the insurance company to the PPDO.

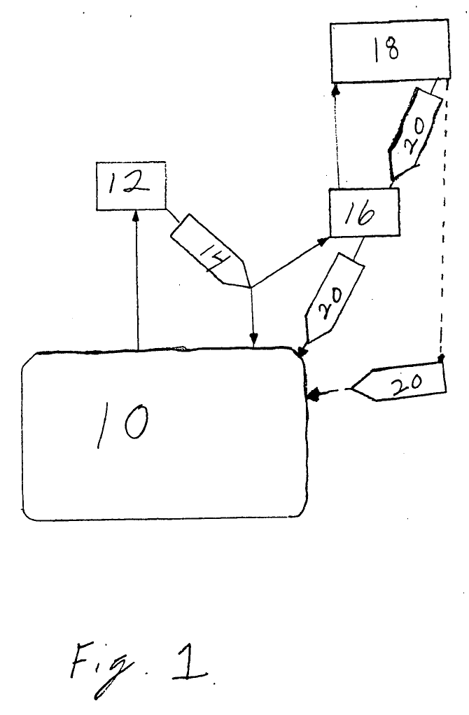

FIG. 1 illustrates an embodiment of the present invention for the generation and issuance of a prescription, as well as for product distribution to a consumer. Although a customer can enter into a contract with a pharmacy product distribution organization (“PPDO”), as described above, at virtually any time, preferably consumer 10 first contacts licensed physician 12 regarding a new or pre-existing medical concern. Physician 12 then issues prescription 14 to consumer 10 and/or to PPDO 16. The PPDO can be an existing pharmacy, pharmaceutical distribution company, pharmaceutical company, a newly created distributing organization, or the like. If physician 12 issues prescription 14 directly to consumer 10 and not to PPDO 16, then consumer 10 preferably forwards prescription 14 on to PPDO 16.

If PPDO 16 is not a manufacturer or wholesaler of the pharmacy product of prescription 14, PPDO 16 then preferably places an order to Pharmacy Product Manufacturer/Wholsaler (“PPM/W”) 18 for pharmacy product 20. PPM/W 18 preferably ships product 20 to PPDO 16 who in-turn ships PPDO on to consumer 10. Alternatively, if PPDO 16 is not the manufacturer or wholesaler of pharmacy product 20, PPM/W can ship product 20 directly to consumer 10. If PPDO 16 is also the PPM/W of pharmacy product 20, PPDO 16 can, or course, ship the product directly to consumer 10 from its inventory. Preferably, pharmacy product 20 which is dispensed to consumer 10 is an entire prescription for the product, such as for a six month, one year, or longer supply of pharmacy product 20, as limited by the term of the prescription and the efficacy of the product.

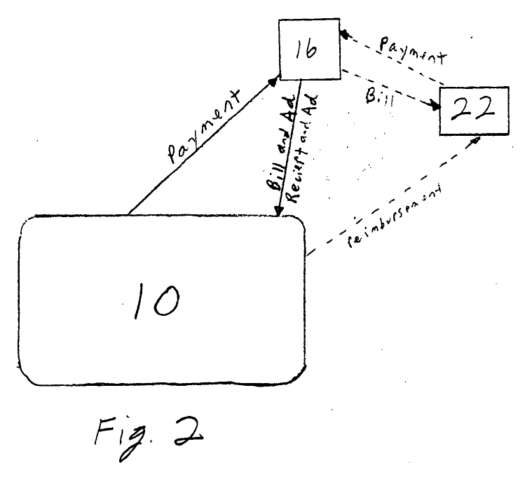

FIG. 2 illustrates an embodiment of the present invention for the billing and payment of pharmacy product 20. As illustrated therein, after or upon shipping product 20 to consumer 10, PPDO 16 then preferably begins billing consumer 10 at regular intervals for portions of the amount due for product 20. Although those skilled in the art will readily recognize numerous billing cycles and amounts 15 can be created, after studying this application, consumer 10 is preferably billed monthly, bimonthly, or weekly for pharmacy product 20. In one embodiment, consumer 10 is billed by Pharmacy Product Distribution Outlet (“PPDO”) 16 and pays the full amount of the bill directly to PPDO 16. In an alternative embodiment, PPDO 16 bills consumer 10 and/or a healthcare insurance provider (“provider”) 22. Provider 22 can be any form of insurance provider including but not limited to a private healthcare insurance provider, Medicare, Medicaid, and the like. In this embodiment, provider 22 pays all or a portion of the amount billed and the consumer pays any remaining portion either directly to PPDO 16 or as a reimbursement to provider 22.

In addition to creating a continuous and ongoing relationship with consumer 10, PPDO 16 is also provided the ability to advertise directly to consumer 10 in conjunction with the billing statements that are regularly sent to consumer 10. The billing statements can be sent to consumer 10 in any manner known in the art including but not limited to electronically via the e-mail, via facsimile, via regular mail, via the telephone, with combinations thereof, and the like. By having the opportunity to advertise on a regular basis directly to targeted consumers, PPDO 16 can thus advertise its services directly to customer 10, can sell or license advertising space to one or more entities, or can do combinations thereof.

In an alternative embodiment of the present invention, the regular payments can be automatically debited from customer's banking account. In this embodiment, customer 10 can optionally be issued a receipt via any manner known in the art. If customer 10 is issued a receipt for an automatic payment, PPDO 16 then thus has another opportunity to use, sale, lease, or license advertising capabilities to customer 10.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above and/or in the attachments, and of the corresponding application(s), are hereby incorporated by reference.

What is claimed is:

1. A method for distributing and paying for prescriptions, the method comprising the steps of:
a customer contracting with a pharmacy product distribution organization to make installment payments for prescriptions;
a physician issuing a full prescription for a pharmacy product;
a pharmacy product distribution organization shipping the full quantity of medical product prescribed; and
installment payments being made for the prescribed product.

2. The method of claim 1 wherein the installment payments are paid in response to billing statements sent by the distribution organization.

3. The method of claim 1 wherein the installment payments are automatically paid by the customer.

4. The method of claim 3 wherein the distribution organization issues a receipt for payments made automatically by the customer.

5. The method of claim 1 wherein the distribution organization issues a receipt for payments made by the customer.

6. The method of claim 1 wherein the distribution organization sends advertisements to a customer.

7. The method of claim 6 wherein the advertisements are sent to a customer in conjunction with a billing statement.

8. The method of claim 6 wherein the advertisements are sent to a customer in conjunction with a receipt.

9. The method of claim 6 wherein the distribution organization sells advertising space to a third party.

10. The method of claim 1 wherein at least a percentage of each installment payment is paid by an insurance provider.

11. The method of claim 10 wherein the customer pays at least a portion of the installment payments.

12. A method for distributing and paying for prescriptions, the method comprising the steps of:
contracting with a product distributor, the contract providing for installment payments to be made to the product distributor;
issuing a prescription;
providing a prescribed product to the individual named on the prescription; and
providing installment payments to a distributor.

13. The method of claim 12 wherein the contracting step comprises a customer contracting with a product distributor.

14. The method of claim 13 wherein the contracting step comprises an insurance provider contracting with a product distributor.

15. The method of claim 14 further comprising the step of a customer contracting with the insurance provider, wherein the customer contracts to make all or a percentage of each installment payment to the insurance provider.

16. The method of claim 12 wherein the step of issuing a prescription comprises issuing a full prescription.

17. The method of claim 12 wherein the providing a prescribed product step-comprises dispensing a prescribed product to the individual named on the prescription.

18. The method of claim 12 wherein the providing a prescribed product step comprises the individual named on the prescription taking possession of the product at a distribution outlet.

19. The method of claim 12 wherein the step of providing installment payments comprises an individual making at least a percentage of each installment payment to the product distributor.

20. The method of claim 12 wherein the step of providing installment payments comprises an insurance provider making at least a percentage of each installment payment to the product distributor.

21. The method of claim 12 further comprising the step of providing a bill to an individual named on the prescription.

22. The method of claim 21 further comprising the step of providing advertisements along with the bill.

23. The method of claim 22 further comprising the step of selling advertisement space.

24. The method of claim 12 further comprising the step of providing installment payments comprises automatically deducting at least one installment payment from an account.

25. The method of claim 12 further comprising the step of providing a receipt for payment.

26. The method of claim 25 further comprising the step of providing advertisements along with the receipt for payment.
